(19) United States
(12) Patent Application Publication
(10) Pub. No.: US 2016/0170386 A1
(43) Pub. Date: Jun. 16, 2016

(54) ELECTRONIC DEVICE AND CONTROL METHOD USING ELECTRONIC DEVICE

(71) Applicant: HON HAI PRECISION INDUSTRY CO., LTD., New Taipei (TW)

(72) Inventor: PEI-CHONG TANG, New Taipei (TW)

(21) Appl. No.: 14/864,247

(22) Filed: Sep. 24, 2015

(30) Foreign Application Priority Data
Dec. 16, 2014 (CN) 201410774066.6

(51) Int. Cl. G05B 15/02

(52) U.S. Cl. CPC G05B 15/02

(57) ABSTRACT

A control method for controlling a controlled device using an electronic device includes detecting touches on a preset touchable area on a touch panel of the electronic device, and acquiring user operation data from the electronic device when at least two touches are detected within a first predetermined duration. The electronic device can control the controlled device to perform predetermined actions in accordance with the user operation data by sending control commands to the controlled device. The controlled device changes state, to move into a preset safe state when no touches are detected within a second predetermined duration within a second predetermined duration.

### CROSS-REFERENCE TO RELATED APPLICATIONS

This application claims priority to Chinese Patent Application No. 201410774066.6 filed on Dec. 16, 2014, the contents of which are entirely incorporated by reference herein.

### FIELD

The subject matter herein generally relates to a control method using an electronic device.

### BACKGROUND

Electronic devices (e.g., mobile phones or tablet computers) have been widely used for controlling various controlled devices, such as industrial equipment. If a wrong operation inputs on the electronic device because of a user mistake, it may cause dangerous accidents.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device in communication with a controlled device.

FIG. 2 is a diagrammatic view of an example embodiment of a preset touchable area on a touch panel of an electronic device.

FIG. 3 is a block diagram of an example embodiment of function modules of a control system.

FIG. 4 is a flowchart of an example embodiment of a control method using an electronic device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

The term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY™ flash memory, and hard disk drives. The term “comprising” means “including, but not necessarily limited to”; it specifically indicates open-ended inclusion or membership in a so-described combination, group, series and the like.

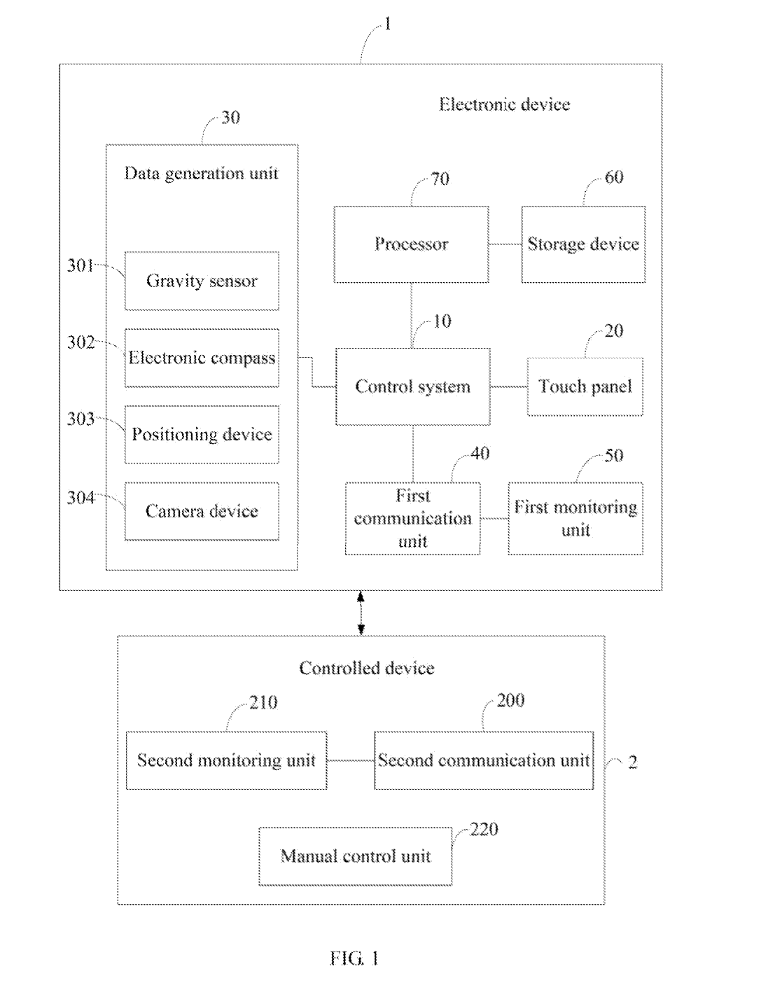

FIG. 1 illustrates an electronic device in communication with a controlled device. In at least one embodiment as shown in FIG. 1, an electronic device 1 can communicate with a controlled device 2 via a wireless communication (for example, a WIFI™ communication, a BLUETOOTH™ communication, or any other suitable short distance wireless communication protocol) or a wired connection (for example, a Local Area Network connection, or an Ethernet Network connection). The electronic device 1 can control the controlled device 2 to perform one or more predetermined actions.

As shown in FIG. 1, the electronic device 1 includes, but is not limited to, a control system 10, a touch panel 20, a data generation unit 30, a first communication unit 40, a first monitoring unit 50, a storage device 60, and at least one processor 70. The controlled device 2 can include, but is not limited to, a second communication unit 200, a second monitoring unit 210, and a manual control unit 220. The electronic device 1 can be a mobile phone, a tablet computer, or any other electronic device which can communicate electronically and process data. The controlled device 2 can be a computer numerical control machine, an industrial robot, or an automated guided vehicle, or any other industrial equipment. FIG. 1 illustrates only one example of the electronic device 1, other examples can include more or fewer components than illustrated, or have a different configuration of the various components in other embodiments.

In at least one embodiment, the control system 10 is connected to the touch panel 20, the data generation unit 30, and the first communication unit 40.

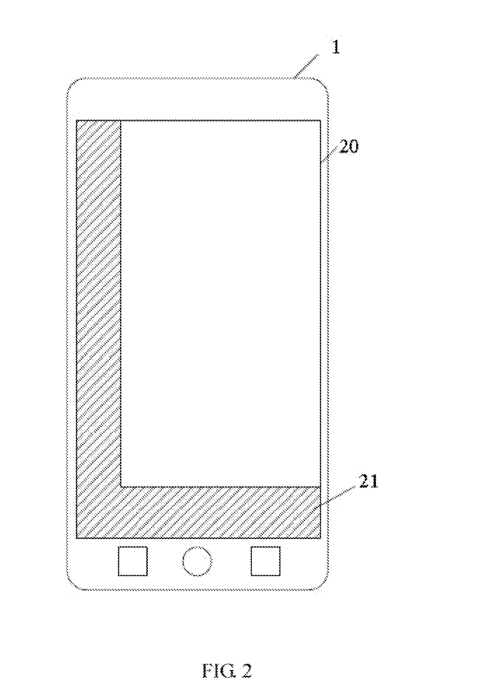

In at least one embodiment, the touch panel 20 can be a touch screen supporting multiple touches, such as resistive touch screen or capacitive touch screen. The touch panel 20 can detect touches according to user operations, and send signals of the touches to the control system 10. In some embodiments, a preset touchable area 21 is set out on the touch panel 20; to detect touches by one or more fingers of the user, as shown in FIG. 2.

In at least one embodiment, the data generation unit 30 can generate data as to user operations when the touch panel 20 is touched, and then send the user operations data to the control system 10.

In some embodiments, the data generation unit 30 can include, but is not limited to, a gravity sensor 301, an electronic compass 302, a positioning device 303, and a camera 304. The gravity sensor 301 can detect movement of the electronic device 1, for example, accelerations, velocities of movements, and movement directions. The electronic compass 302 can detect other movement of the electronic device 1, for example, angles and/or rotations. The positioning device 303 can detect position of the electronic device 1, for example, within three-dimensional coordinates. The positioning device 303 can be a global positioning system device. The camera 304 can capture images, such as images of user's gestures and images of work environment of the controlled device 2.

In at least one embodiment, the storage device 60 can include various types of non-transitory computer-readable storage mediums. For example, the storage device 60 can be an internal storage system, such as a flash memory, a random access memory (RAM) for temporary storage of information, and/or a read-only memory (ROM) for permanent storage of information. The storage device 60 can also be an external storage system, such as a hard disk, a storage card, or a data storage medium.

In at least one embodiment, the at least one processor 70 can be a central processing unit (CPU), a microprocessor, or other data processor chip.

In at least one embodiment, the first communication unit 40 can communicate with the second communication unit 200. The first monitoring unit 50 and the second monitoring unit 210 can monitor and determine an existence and a normal working of a communications channel between the first communication unit 40 and the second communication unit 200.

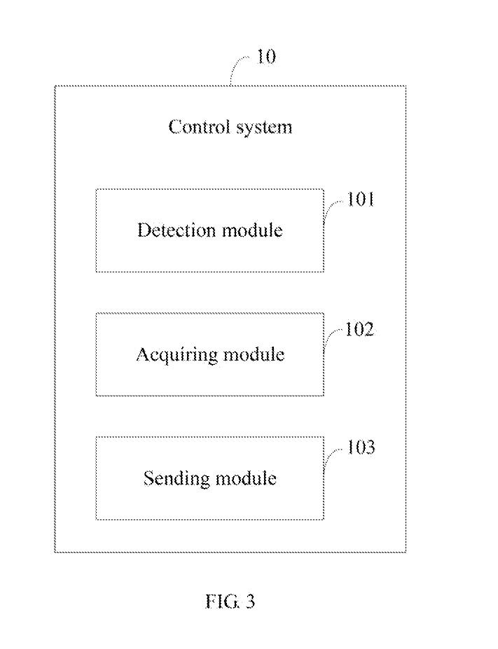

FIG. 3 shows function modules of the control system 10. In at least one embodiment, as shown in FIG. 3, the control system 10 can include a detection module 101, an acquiring module 102, and a sending module 103. The function modules 101, 102, and 103 can include computerized codes in the form of one or more programs which are stored in the storage device 60 of the electronic device 1. The at least one processor 70 of the electronic device 1 executes the computerized codes to provide functions of the function modules 100-103. The function modules 101, 102, and 103 also can include hardware components with specific functions.

In at least one embodiment, the detection module 101 can detect touches applied to the preset touchable area 21 on the touch panel 20.

In some embodiments, the touch panel 20 can recognize touches of fingers of the user, and transmit signals representing the touches (“touch signals”). When the touch panel 20 detects at least two touches, the touch panel 20 can send touch signals to the control system 10. Otherwise, if only one touch is detected, the touch panel 20 does not send a touch signal to the control system 10. In other embodiments, once the touch panel 20 detects one or more touches, a touch signal or signals are sent to the control system 10. Accordingly, transmission conditions of the touch signals can be changed according to user requirements or predeterminations. In some embodiments, the at least two touch signals can include one continuous touch on the preset touchable area 21 within a first predetermined duration (e.g., 10 seconds). For example, the user keeps touching the preset touchable area 21 with one finger, while another finger touches any area on the touch panel 20, so as to generate control commands as described below. When the user touches the preset touchable area 21 with one finger, the touch panel 20 can detect a single-touch signal. When the user touches the preset touchable area 21 with two fingers, the touch panel 20 can detect multi-touch signals.

In at least one embodiment, the acquiring module 102 can acquire user operation data from the data generation unit 30, when at least two touches on the preset touchable area 21 have been detected within a predetermined duration.

In some embodiments, the user operation data can include, but is not limited to, movement detected by the gravity sensor 301, other movement detected by the electronic compass 302, position detected by the positioning device 303, and images captured by the camera 304, or a combination of one or more kinds of events as mentioned above. When the data generation unit 30 detects the user operation data, the data generation unit 30 sends the user operation data to the acquiring module 102.

In at least one embodiment, the sending module 103 can generate control commands by analyzing the user operation data acquired from the data generation unit 30, and control the controlled device 2 to perform predetermined actions by sending the control commands to the controlled device 2.

In some embodiments, the sending module 103 can also generate a security control command when no touches has been detected from the preset touchable area 21 within a second predetermined duration, and send the security control command to control the controlled device 2 to change into a preset safe state. After receiving the security control command, the controlled device 2 can change into the preset safe state, and stops performing any predetermined action.

In some embodiments, the sending module 103 firstly sends the control commands or the security control command to the first communication unit 40. Secondly, the first monitoring unit 50 monitors whether a communication mode between the first communication unit 40 and the second communication unit 200 is present and is operating normally. If communication is open, the first communication unit 50 can send the control commands or the security control command to the controlled device 2. If the communication is not open or working abnormally, the first communication unit 50 can stop sending the control commands or the security control command to the controlled device 2. When the communication between the controlled device 2 and the electronic device 1 is not open or is working abnormally, the controlled device 2 can activate a manual control unit 220. When the manual control unit 220 is activated, the users can control the controlled device 2 manually, that is to say physically.

In some embodiments, the first monitoring unit 50 and the second monitoring unit 200 can use a watchdog program to monitor the communication between the first communication unit 40 and the second communication unit 200. For example, the watchdog program can send connection commands (such as ping commands) to connect the first communication unit 40 and the second communication unit 200. If the first communication unit 40 and the second communication unit 200 can respond to each other, it indicates that communication between the first communication unit 40 and the second communication unit 200 is operating normally.

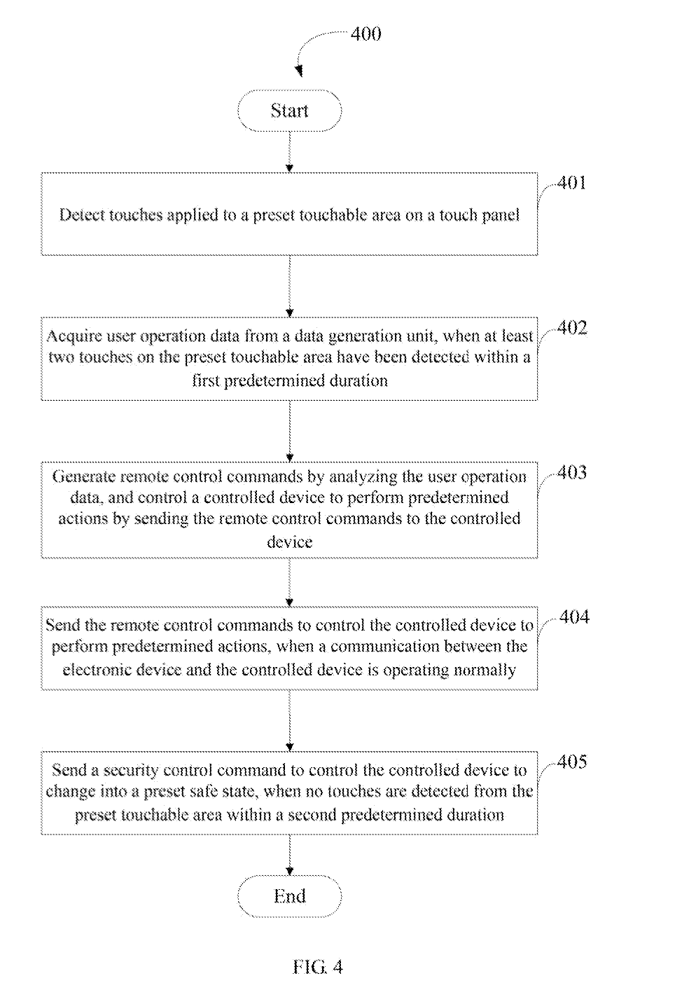

FIG. 4 illustrates a flowchart in accordance with an example embodiment. An example method 400 is provided by way of example, as there are a variety of ways to carry out the method. The example method 400 described below can be carried out using the configurations illustrated in FIG. 1, and various elements of these figures are referenced in explaining the example method. Each block shown in FIG. 4 represent one or more processes, methods, or subroutines carried out in the example method 400. Furthermore, the illustrated order of blocks is illustrative only and the order of the blocks can be changed. The example method 400 can begin at block 401. Depending on the embodiment, additional blocks can be utilized and the ordering of the blocks can be changed.

At block 401, a detection module detects touches applied to the preset touchable area 21 on the touch panel 20.

At block 402, an acquiring module acquires user operation data from the data generation unit 30, when at least two touches on the preset touchable area 21 have been detected within the first predetermined duration.

At block 403, a sending module generates control commands by analyzing the user operation data acquired from the data generation unit 30, and controls the controlled device 2 to perform predetermined actions by sending the control commands to the controlled device 2.

At block 404, a sending module sends the control commands to control the controlled device 2 to perform predetermined actions provided that the communication between the electronic device 1 and the controlled device 2 is operating normally.

In some embodiments, when a communication between the electronic device 1 and the controlled device 2 is not open or is working abnormally, control commands will not be sent to the controlled device 2.

At block 405, a sending module sends the security control command to control the controlled device 2 to change into a preset safe state, when no touches has been detected from the preset touchable area 21 within a second predetermined duration.

The user should hold the electronic device 1 with at least one hand on the preset touchable area 21. If timely touches on the preset touchable area are not made, for example when the electronic device 1 is not in the user's possession, the controlled device 2 changes into the preset safety status immediately.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. An electronic device in signal communication with a controlled device, the electronic device comprising:
a touch panel;
a data generation unit;
at least one processor coupled to the touch panel and the data generation unit; and
a storage device storing one or more programs, which when executed by the at least one processor cause the at least one processor to:
detect touches applied on a preset touchable area on the touch panel;
acquire user operation data from the data generation unit when at least two touches on the preset touchable area are detected within a first predetermined duration, and control the controlled device to perform predetermined actions in accordance with the user operation data by sending control commands to the controlled device; or
control the controlled device to change into a preset safe state when no touches are detected from the preset touchable area within a second predetermined duration by sending a security control command to the controlled device.

2. The electronic device according to claim 1, wherein the at least two touches comprise one continuous touch on the preset touchable area within the first predetermined duration.

3. The electronic device according to claim 2, wherein the at least two touches are triggered by a single-touch operation or a multi-touch operation on the preset touchable area.

4. The electronic device according to claim 1, wherein the user operation data comprises movement detected by a gravity sensor of the electronic device, angles or rotations detected by an electronic compass of the electronic device, position of the electronic device detected by a positioning device, and images captured by a camera.

5. The electronic device according to claim 1, wherein the at least one processor further:
when a communication between the electronic device and the controlled device is preset and is operating normally, sends the control commands to the controlled device; and
when a communication between the electronic device and the controlled device is not open or working abnormally, stops sending the control commands to the controlled device.

6. A computer-implemented method for controlling a controlled device being executed by at least one processor of an electronic device having a touch panel and a data generation unit, the method comprising:
detecting touches applied on a preset touchable area on the touch panel;
acquiring user operation data from the data generation unit, when at least two touches on the preset touchable area are detected within a first predetermined duration, and control the controlled device to perform predetermined actions in accordance with the user operation data by sending control commands to the controlled device; or
controlling the controlled device to change into a preset safe state when no touches are detected from the preset touchable area within a second predetermined duration by sending a security control command to the controlled device.

7. The method according to claim 6, wherein the at least two touches comprise one continuous touch on the preset touchable area within the first predetermined duration.

8. The method according to claim 7, wherein the at least two touches are triggered by a single-touch operation or a multi-touch operation on the preset touchable area.

9. The method according to claim 6, wherein the user operation data comprises movement detected by a gravity sensor of the electronic device, angles or rotations detected by an electronic compass of the electronic device, position of the electronic device detected by a positioning device, and images captured by a camera.

10. The method according to claim 6, further comprising:
when a communication between the electronic device and the controlled device is preset and is operating normally, sending the control commands to the controlled device; and
when a communication between the electronic device and the controlled device is not open or working abnormally, stopping sending the control commands to the controlled device.

11. A non-transitory storage medium having stored thereon instructions that, when executed by at least one processor of an electronic device, causes the at least one processor to perform a method for controlling a controlled device, the electronic device comprising a touch panel and a data generation unit, wherein the method comprises:
detecting touches applied on a preset touchable area on the touch panel;
acquiring user operation data from the data generation unit, when at least two touches on the preset touchable area have been detected within a first predetermined duration, and control the controlled device to perform predetermined actions in accordance with the user operation data by sending control commands to the controlled device; or
controlling the controlled device to change into a preset safe state when no touches are detected from the preset touchable area within a second predetermined duration by sending a security control command to the controlled device.

12. The non-transitory storage medium according to claim 11, wherein the at least two touches comprise one continuous touch on the preset touchable area within the first predetermined duration.

13. The non-transitory storage medium according to claim 12, wherein the at least two touches are triggered by a single-touch operation or a multi-touch operation on the preset touchable area.

14. The non-transitory storage medium according to claim 11, wherein the user operation data comprises movement detected by a gravity sensor of the electronic device, angles or rotations detected by an electronic compass of the electronic device, position of the electronic device detected by a positioning device, and images captured by a camera.

15. The non-transitory storage medium according to claim 11, further comprising:
when a communication between the electronic device and the controlled device is preset and is operating normally, sending the control commands to the controlled device; and
when a communication between the electronic device and the controlled device is not open or working abnormally, stopping sending the control commands to the controlled device.
